(19) United States
(12) Patent Application Publication
(10) Pub. No.: US 2020/0201763 A1
(43) Pub. Date: Jun. 25, 2020

(54) MEMORY HIERARCHY-AWARE PROCESSING

(71) Applicant: Advanced Micro Devices, Inc., Sunnyvale, CA (US)

(72) Inventor: Shuai Che, Bellevue, WA (US)

(73) Assignee: Advanced Micro Devices, Inc., Sunnyvale, CA (US)

(21) Appl. No.: 16/806,690

(22) Filed: Mar. 2, 2020

Related U.S. Application Data
(63) Continuation of application No. 15/497,162, filed on Apr. 25, 2017.

(51) Int. Cl. G06F 12/0811; G06F 9/50

(52) U.S. Cl. CPC G06F 12/0811; G06F 9/505; G06F 2209/5017; G06F 2212/1016; G06F 2209/501; G06F 9/5088

(57) ABSTRACT

Improvements to traditional schemes for storing data for processing tasks and for executing those processing tasks are disclosed. A set of data for which processing tasks are to be executed is processed through a hierarchy to distribute the data through various elements of a computer system. Levels of the hierarchy represent different types of memory or storage elements. Higher levels represent coarser portions of memory or storage elements and lower levels represent finer portions of memory or storage elements. Data proceeds through the hierarchy as “tasks” at different levels. Tasks at non-leaf nodes comprise tasks to subdivide data for storage in the finer granularity memories or storage units associated with a lower hierarchy level. Tasks at leaf nodes comprise processing work, such as a portion of a calculation. Two techniques for organizing the tasks in the hierarchy presented herein include a queue-based technique and a graph-based technique.

### CROSS REFERENCE TO RELATED APPLICATIONS

This application is a continuation of U.S. patent application Ser. No. 15/497,162 filed Apr. 25, 2017, the contents of which are incorporated by reference as if fully set forth herein.

### BACKGROUND

Advances in computer systems are providing increasing numbers and types of processing, memory, and storage elements with varying characteristics. The traditional model for computer operation is one in which a hard drive is used as permanent storage, system memory is used to store a large set of working data, and in which caches and processor registers are used to store a smaller, more focused data set. Future memory systems will become increasingly deeper, more asymmetric, and more heterogeneous in terms of memory technology composition, and development for such systems is continuously occurring.

### BRIEF DESCRIPTION OF THE DRAWINGS

A more detailed understanding may be had from the following description, given by way of example in conjunction with the accompanying drawings wherein:

FIG. 1 is a block diagram of a computer system, in which one or more aspects of the present disclosure are implemented, according to an example;

FIG. 2 illustrates a data access hierarchy, according to an example;

FIG. 3 illustrates a directed acyclic graph (“DAG”)-based hierarchy, according to an example; and

FIG. 4 is a flow diagram of a method for processing data according to a memory organization hierarchy, according to an example.

### DETAILED DESCRIPTION

The present disclosure is directed to improvements to traditional schemes for storing data for processing tasks and for executing those processing tasks. A large set of data for which a particular set of processing tasks is to be executed is processed through a hierarchical representation (“hierarchy”) to distribute the data through various elements of a computer system. Levels of the hierarchy represent different types of memory or storage elements, with higher levels representing coarser portions of memory or storage elements and lower levels representing finer portions of memory or storage elements. Different nodes in each level are associated with specific individual memories or storage units, or subdivision thereof.

Data proceeds through the hierarchy as “tasks” at different levels. Tasks at non-leaf nodes comprise tasks to subdivide data associated with the task for storage in the finer granularity memories or storage units associated with a lower hierarchy level. Tasks at leaf nodes comprise processing work, such as a portion of a calculation, for the data associated with such tasks. Together, the tasks associated with the leaf nodes comprise the overall “payload” data processing that is the eventual purpose of the distribution of the data through the hierarchy. The tasks associated with non-leaf nodes are tasks for navigating the data through the various memories and storage units for efficient organization and distribution. While it is described herein that processing tasks are performed for the leaf nodes, in some examples, processing tasks are performed for non-leaf nodes as well. For example, if a particular non-leaf node is associated with memory accessed by the CPU and that non-leaf node also transmits data to another node for access by a discrete GPU, then the non-leaf node associated with the CPU memory may perform tasks other than just splitting up the data.

Two techniques for organizing the tasks in the hierarchy presented herein include a queue-based technique and a graph-based technique. In the queue-based technique, each node includes queue that stores tasks waiting to be processed (“ready tasks”) and tasks that have been processed and are waiting for processing at a lower level. When a “ready” task is processed, the “ready” task is converted to a wait task and “ready” sub-tasks are generated for lower hierarchy levels. A wait task is considered complete when all sub-tasks generated from that task are complete. In the graph-based technique, each node stores a number of tasks and each task is a vertex in the graph. Vertices point to other tasks in lower hierarchy levels. A task that is complete is freed. A task is complete when all child tasks are complete.

Additional features, such as load balancing, are facilitated by the above techniques. Load balancing is performed by comparing the number of tasks (represented by queue elements or graph vertices) at each node and evening out the tasks based on this information.

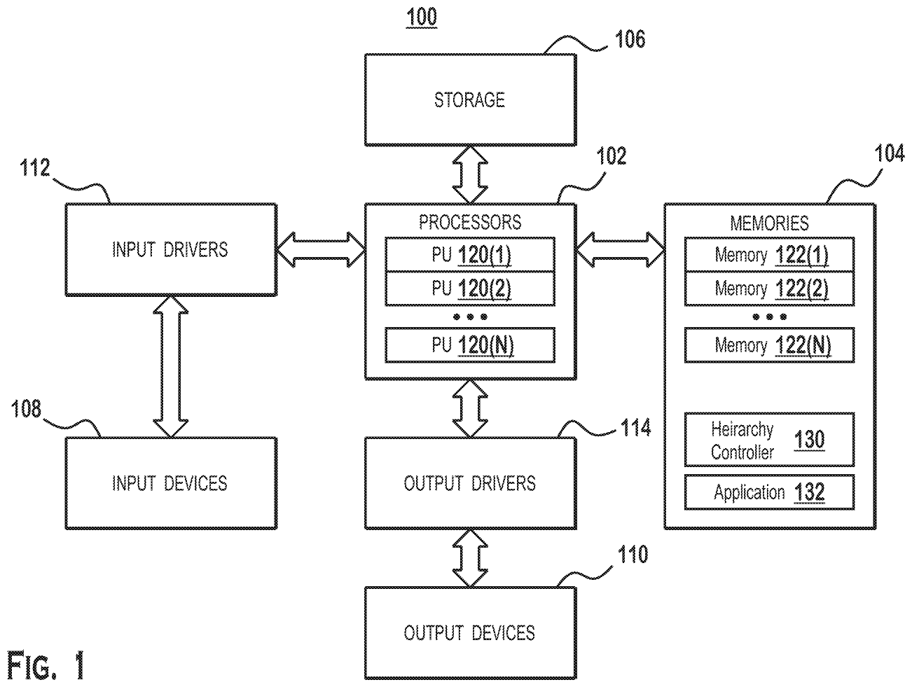

FIG. 1 is a block diagram of a computer system 100, in which one or more aspects of the present disclosure are implemented, according to an example. The computer system 100 includes processors 102, which include one or more processing units 120.

The processing units 120 include any type of processing device configured to process data, such as one or more central processing units (CPU), one or more graphics processing unit (GPU), one or more shared-die CPU/GPU devices, or any other processing device. The number of processing units 120 included in the processors 102 may vary.

The memories 104 include memory units 122. Each memory unit 122 is one of a number of different types of memory, such as volatile memory, non-volatile memory, static random access memory, dynamic random access memory, read-only memory, readable and writeable memory, caches of various types, and/or any other type of memory suitable for storing data and supporting processing on the processors 102.

The storage 106 includes one or more storage elements (also referred to as “storage units”), where each storage element includes a fixed or removable storage device or portion thereof, for example, a hard disk drive, a solid state drive, an optical disk, or a flash drive, or portion thereof. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals). The input drivers 112 communicate with the processor 102 and the input devices 108, and permit the processors 102 to receive input from the input devices 108. The output drivers 114 communicate with the processor 102 and the output devices 110, and permit the processor 102 to send output to the output devices 110.

Programs executing in the processors 102 manipulate data stored in the memories 104 and in storage 106. The memories 104 include multiple different types of memory units, some of which vary in terms of access characteristics, such as by having different capacity, latency, or bandwidth characteristics. Typically, data is stored in a large capacity memory or storage device until needed by a program and is then read into other, lower latency memory or storage for immediate use. The computer system utilizes the various memories 104 and storage units in a hierarchical manner, reading memory into successively lower-latency memories. In one example, a hierarchy includes a hard disk drive, a dynamic random access memory module, a level 2 cache, a level 1 cache, a level 0 cache, and processor registers. In another example, a hierarchy includes a hard disk drive, a solid state disk drive, a dynamic random access memory, a die-stacked memory module, a number of cache levels, and processor registers.

In some computer systems, the manner in which data is read in through a memory occurs in an ad hoc, on-demand manner, with no ability for an application (and therefore, application developers) to control the manner in which data is read into specific memories at different levels of the hierarchy. In such systems, it is not possible to obtain benefits that result from controlling the manner in which data is distributed through the memory hierarchy. Such benefits include improvements in performance (computing speed, memory footprint, or other performance improvements) that result from customized data placement. In other computer systems, specific knowledge of the characteristics of memories included in a computer system is required to be pre-programmed into an application order for an application to be able to control the manner in which data is distributed through the hierarchy.

The teachings herein provide techniques for allowing programmatic control over the manner in which data is distributed through a memory hierarchy. A memory hierarchy controller 130, which executes on one of the processing units 120 of the computing system 100, and/or on one or more other processing units not shown, controls the manner in which data for an application is distributed through a memory hierarchy. The memory hierarchy controller 130 controls this data flow at the specific request of an application 132 for which the data flow is occurring. The memory hierarchy controller 130 is implemented in any technically feasible manner. In various examples, the memory hierarchy controller 130 is an application programming interface (“API”) called by the application 132 to perform the data organization operations described herein. In some implementations, the memory hierarchy controller 130 and the application 132 are a single entity (such as a single application). In such implementations, the operations of the memory hierarchy controller 130 described herein and the operations of the application 132 described herein are performed by the single entity. In other implementations, the memory hierarchy controller 130 and the application 132 are separate entities, with the application 132 requesting that the memory hierarchy controller 130 perform specific functionality. Additionally, although certain operations are described herein as being performed by the memory hierarchy controller 130 and other operations are described herein as being performed by the application 132, it should be understood that any of the operations described as being performed by the memory hierarchy controller 130 may alternatively be performed by the application 132 and any of the operations described as being performed by the application 132 may alternatively be performed by the memory hierarchy controller 130.

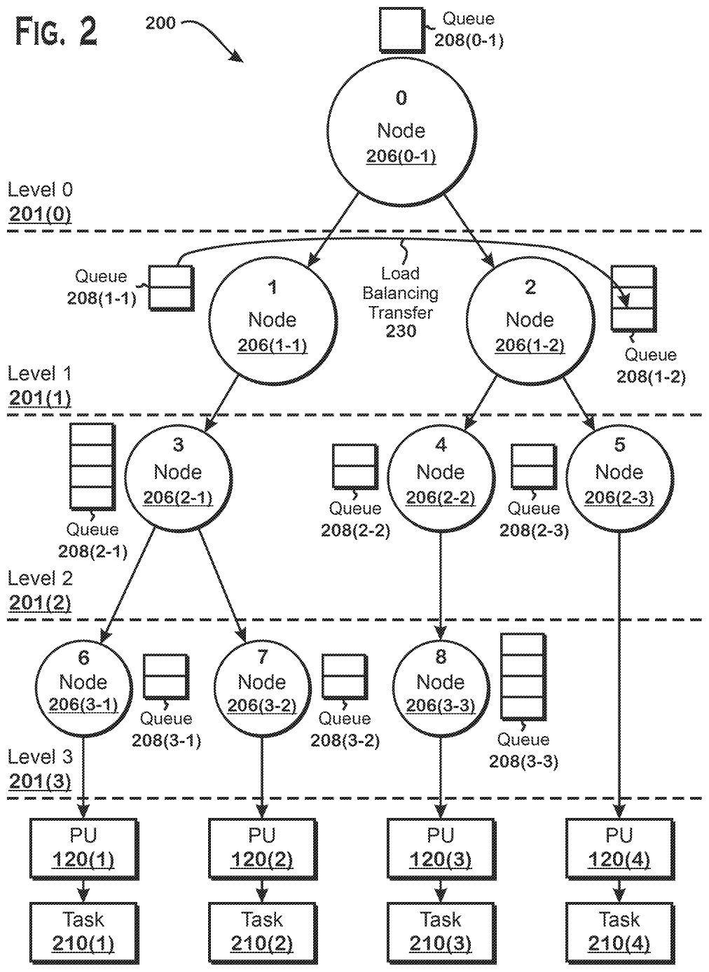

FIG. 2 illustrates a data access hierarchy 200, according to an example. The data access hierarchy 200 is a logical construct that roughly reflects logical relationships between various memories 122 and/or storage units 106 of the computing system 100. The data access hierarchy 200 includes a number of data access hierarchy levels 201. Each data access hierarchy level 201 is associated with a different way in which data is stored in the memories 122 and/or storage units 106.

More specifically, each data access hierarchy level 201 is associated with a specific type of memory unit 122 or storage unit 106. Generally, data access hierarchy levels 201 that are higher up in the data access hierarchy 200 are associated with larger units of data and memories 122 or storage units 106 of larger capacity, higher latency memories or storage elements. In one example, a first data access hierarchy level 201(0) is associated with a hard disk drive, a second data access hierarchy level 201(1) is associated with a solid state disk drive, a third data access hierarchy level 201(2) is associated with dynamic random access memory, and so on. Each hierarchy level 201 has one or more hierarchy nodes 206, each being associated with a certain portion of the total data set that the application is processing. A hierarchy node 206 at a particular hierarchy level is associated with less than or the same amount of data as the parent node of that hierarchy node 206. Different hierarchy levels 201 may be associated with the same type of memory unit 122 or storage unit 106 but at a different level of coarseness. For two hierarchy levels 201 associated with the same type of memory unit 122 or storage unit 106, a hierarchy node 206 at a higher hierarchy level 201 has hierarchy nodes 206 that are associated with larger chunks of data than hierarchy nodes 206 at a lower hierarchy level 201. In one example, hierarchy level 201(1) is associated with 1 MB chunks of DRAM and hierarchy level 201(2) is associated with 64 kB chunks of DRAM.

The purpose of the data access hierarchy levels 201 is to specify how data is transmitted between memories and storage elements for eventual use in processing tasks specified by an application. The application specifies both how the data is to be transmitted between hierarchy levels 201 and also the processing tasks that are to be performed at the lowest hierarchy level 201 (also referred to as a “leaf hierarchy level”). Hierarchy levels 201 that are not the lowest are also referred to herein as “non-leaf hierarchy levels.”

At any particular time, each hierarchy node 206 stores one or more tasks to be performed. The term “task” varies in meaning depending on whether the task is a task in a non-leaf hierarchy level or a task in a leaf hierarchy level. More specifically, a task in a non-leaf hierarchy level refers to splitting up data associated with the task and sending the split up data to a lower hierarchy level 201. A task in a leaf hierarchy level, also referred to herein more specifically as a “processing task,” refers to performing payload processing (i.e., the end-processing on data, such as image manipulation, matrix multiplication, or any other type of processing, as specified by the application 132).

The hierarchy controller 130 processes data at any particular non-leaf hierarchy level by dividing the data up as specified by the application 132 and transmitting the divided data to the memory units or storage elements specified for the next-lowest data access hierarchy level 201. At the data access hierarchy level 201 immediately above the leaf hierarchy level, the hierarchy controller 130 divides the data up into chunks specified by the application 132 for performance of individual processing tasks specified by the application 132. At a leaf hierarchy level, data exists in discrete chunks for processing in processing units. Each node 206 in a leaf hierarchy level is associated with a specific set of one or more processing units 120. For any particular processing task in a leaf node, the memory hierarchy controller 130 schedules that processing task for execution by a processing unit 120 specified for that leaf node. The processing task includes the operation specified by the application 132. For example, in a matrix manipulation operation, the processing task includes matrix manipulation (e.g., multiplication) operations for the set of data included in a task in a leaf node.

At each hierarchy node 206, a queue 208 is provided to track ready-to-execute and outstanding tasks. For non-leaf nodes 206, ready-to-execute tasks include tasks received from higher hierarchy levels but for which data has not yet been split up, and outstanding tasks include data split up and transmitted to lower hierarchy levels 201 for processing. For leaf nodes 206, the ready-to-execute tasks include tasks that have not yet been scheduled for processing. The outstanding tasks include the actual processing tasks specified to be performed by a processing unit 120 for the data at the leaf node 206, that are currently executing in a processing unit. To reflect these two different types of tasks (“ready-to-execute” and “outstanding”), queues 208 includes two types of entries: “ready” entries and “wait” entries. In some implementations, each node 206 has two queues—one that includes “ready” entries and another that includes “wait” entries. The “ready” entries correspond to the ready-to-execute tasks. The “wait” entries correspond to the outstanding tasks.

When the task associated with a “ready” entry is split up and sent to a node 206 in a lower hierarchy level 201, the node 206 in the higher hierarchy level 201 dequeues the “ready” entry and enqueues a “wait” entry for the task that was split up and the node 206 in the lower hierarchy level 201 enqueues “ready” entries for each task received. Herein, split-up tasks at a lower level that are derived from a task at a higher hierarchy level are referred to as “sub-tasks” of the task from which the sub-tasks derive. When the hierarchy controller 130 notes that all split-up tasks derived from a particular task are complete, the hierarchy controller 130 notes that task as being complete as well. This technique for noting completeness of tasks occurs at each level of the hierarchy 200, so that a node at any particular hierarchy level 201 is noted as complete when all descendants of that node are noted as complete.

The processing performed by the hierarchy controller 130 for each task is capacity-aware. More specifically, in performing a task, the hierarchy controller 130 sends work to children of a node 206 for non-leaf nodes, or to an associated processing unit for leaf nodes, when capacity of all nodes 206 that are children of that node 206 is available. If capacity is not available, the hierarchy controller 130 does not send work, waiting until there is more available capacity in the lower nodes 206. The amount of capacity that is available at a node 206 depends on the amount of space or processing hardware assigned to that node 206. For example, if one node 206 is associated with 1 GB of DRAM, then that node 206 has no more capacity if that node 206 has outstanding tasks that consume 1 GB of memory (or close enough to 1 GB of memory such that no additional tasks can be stored in that 1 GB of memory).

The hierarchy controller 130 is capable of performing load balancing operations. To perform load balancing, the hierarchy controller 130 transfers one or more tasks from a node 206 to the sister of that node 206. In one example, load balancing occurs if a particular node 206 is close to capacity and a sister node 206 of the close-to-capacity node is not close to capacity, although load balancing may occur in other situations as well. A node 206 being close to capacity means that the data for that node is at or above a threshold percentage of the memory space (or storage space) assigned to that node 206. In one example, node 206(1-1) is close to capacity. In response, the hierarchy controller 130 transfers one or more tasks from node 206(1-1) to node 206(1-2). Additionally, in some implementations, in the queue-based hierarchy 200 of FIG. 2, the hierarchy controller 130 determines whether a particular node 206 is close to capacity by determining whether the number of “ready” entries is above a threshold that is based on the available space in the memory or storage assigned to that node 206.

For the queue-based hierarchy 200 of FIG. 2, “ready” tasks, which have not yet been processed for lower hierarchy levels 201, are eligible for load balancing. To perform load balancing for such tasks, which consists of moving the ready task from a first node 206 to a sister of that node 206, the hierarchy controller 130 copies the data for the task from the portion of memory or storage assigned to the first node 206 to the portion of memory or storage assigned to the sister node 206 and deletes the data for that task from the portion of memory or storage assigned to the first node 206. A load balancing transfer 230 is illustrated in FIG. 2.

The hierarchy controller 130 is capable of scheduling tasks in the same hierarchy level 201 for concurrent execution. More specifically, in some instances, the hierarchy controller 130 schedules two or more tasks, assigned to the same node 206 or different nodes 206, for concurrent execution. In one example, the hierarchy controller 130 schedules the splitting of a task in node 206(1-1) for performance simultaneously with a task in node 206(1-2). This simultaneous processing can be done using multiple threads or processes on a single processor, multiple processors, or in any other manner. Note that the term “simultaneous” does not necessarily mean that operations for multiple tasks are performed at the same exact time, since concurrent execution in a single processor may actually be sequential. Additionally, tasks for splitting up data may be performed in any particular manner. For example, tasks to split up data split the data into multiple chunks. In various examples, one chunk is sent to a lower-level node or multiple chunks are set to a lower level node for each task. Although a specific hierarchy of levels is illustrated, it is possible for one or more splitting tasks to skip one or more levels of the hierarchy. In one example, a task that splits up data in node 206(0-1) transmits the data to node 206(2-1) instead of node 206(1-1).

The hierarchy controller 130 is also capable of using a profiling technique to identify which processing unit 120 to execute a particular processing task. More specifically, in the case that the leaf nodes process similar task types, the hierarchy controller 130 has the ability to run a small number of tasks (e.g., one) on processing units 120 of different types and to obtain performance metrics for each of those runs. Then, the hierarchy controller 130 identifies the processing unit 120 that produced the best performance metric (e.g., fastest execution time, smallest memory footprint, or any other metric that could be used) and selects those types of processing units 120 to execute other tasks of the same type. The hierarchy controller 130 selects one or more types of processing units 120 that produced the one or more best performance metric results to execute the processing tasks.

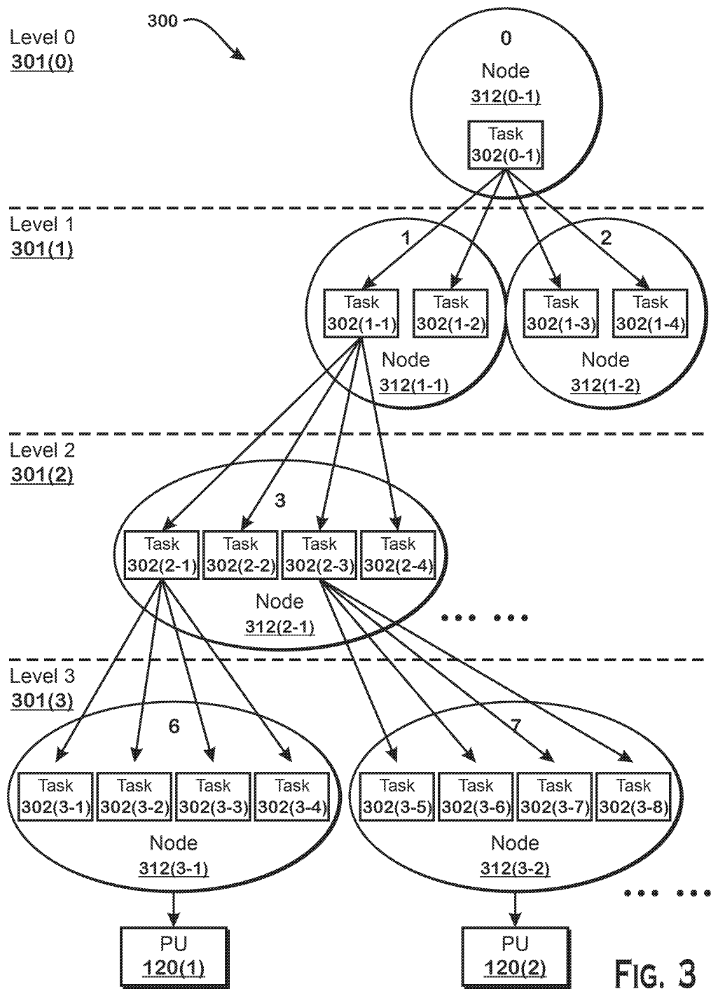

FIG. 3 illustrates a directed acyclic graph (“DAG”)-based hierarchy 300, according to an example. Whereas the hierarchy 200 of FIG. 2 stores data about outstanding tasks in queues at each node, the DAG-based hierarchy 300 stores data about outstanding tasks in nodes of a directed acyclic graph.

The DAG-based hierarchy 300 includes hierarchy levels 301 that are analogous to the hierarchy levels 201 of FIG. 2. More specifically, the hierarchy levels 301 are each associated with a specific type or memory or storage and size of data to be stored in that specific type of memory or storage. The DAG-based hierarchy 300 also includes nodes 312 which are analogous to the nodes 206 of FIG. 2. More specifically, each node 312 is associated with a specific memory unit or storage unit or portion thereof. The DAG-based hierarchy 300 also includes tasks 302, which are analogous to the tasks described with respect to FIG. 2. For non-leaf nodes 312, the tasks 302 represent tasks for splitting up data. For leaf nodes 312, the tasks 302 represent payload processing tasks to be performed on the smallest-sized chunks of data, specified by the application 132.

For non-leaf nodes 312, the hierarchy controller 130 processes tasks 302 by splitting up the data associated with the task as specified by the application 132 and storing the split up data in the memory unit or storage unit, or portion thereof, associated with a node 312 in an immediately-lower hierarchy level 301. For each sub-task, the hierarchy controller 130 generates a new task 302 to be placed within the node 312 at the immediately lower hierarchy level 301. For example, to process task 302(2-1) (in a state prior to the state of the hierarchy 300 illustrated in FIG. 3), the hierarchy controller 130 generates task 302(3-1), task 302(3-2), task 302(3-3), and task 302(3-4), and stores them in the memory unit or storage unit, or portion thereof, associated with node 312(3-1). For leaf nodes 312, the hierarchy controller 130 processes tasks 302 by scheduling the task for execution on a processing unit 120 associated with that leaf node 312.

The tasks 302 that are generated are vertices of a directed acyclic graph. A task 302 in a non-leaf node includes directed connections to sub-tasks of that task 302, which sub-tasks are in the next-lowest hierarchy level 300. The directed acyclic graph 300 is thus formed as a series of directed connections between tasks 302 of different hierarchy levels 300.

When a task 302 in a leaf node 312 completes processing, that task 302 is freed. When all tasks 302 that are children of a particular parent task 302 are freed, the parent task 302 is freed. This freeing occurs recursively up the hierarchy 301. Thus, if all processing tasks that are descendants of a particular task 302 are complete, that particular task 302 is freed due to this recursive freeing action.

The hierarchy controller 130 tracks capacity associated with each node 312 for the purpose of determining whether that node 312 is at capacity or can receive additional data. When data assigned to a particular node 312 fills the associated memory unit or storage unit, or portion thereof, such that there is no more space available for additional tasks 302, the hierarchy controller 130 waits to send additional data to that node 312 until there is again available space.

As with the hierarchy 200, load balancing can be applied with DAG-based hierarchy 300. According to the load balancing technique, the hierarchy controller 130 determines whether one node 312 has a number of tasks 302 that is greater than a threshold number in excess of a sister node (for example, if the threshold is 3, then the hierarchy controller 130 determines whether a node 312 has more than 3 tasks in excess of the other node 312). If the node 312 has greater than the threshold number of tasks in excess of the other node 312, then the hierarchy controller 130 migrates tasks 302 from the one node 312 to the other node 312. Migrating tasks 302 includes moving the task 302 from one node 312 to another node 312, and copying the data for the task 302 from the memory unit or storage unit, or portion thereof, associated with the source node 312 to the memory unit or storage unit, or portion thereof, associated with the destination node 312. In some implementations, only tasks 302 that have not yet been processed (e.g., either for the payload processing, for leaf nodes or to be split for non-leaf nodes) are migrated in this manner.

As with the hierarchy 200, profiling to identify suitable processing units 120 for (leaf) processing tasks can be applied with the DAG-based hierarchy 300. According to the profiling technique, the hierarchy controller 130 schedules a small number of processing tasks on different processing units 120, recording performance metrics for the processing tasks 210, and selects one or more types of processing units 120 for execution of other similar processing tasks based on the performance metrics.

One example way in which to variably perform the function of either subdividing data for a lower hierarchy level or performing a processing task at a leaf hierarchy level (for either the hierarchy 200 or the DAG-based hierarchy 300) is through the use of a recursive function that executes at each node. More specifically, for a task in a particular node, the recursive function is called (by an instance of the recursive function at a higher hierarchy level). Each time the recursive function is called, the recursive function checks if the recursive function is executing for a leaf hierarchy level. If the recursive function is executing for a task in a leaf hierarchy level, then the recursive function performs a specified processing task for the data at the leaf hierarchy level (i.e., performs the payload operation specified by the application 132 for the leaf hierarchy level). If the recursive function is executing for a task in a non-leaf hierarchy level, then the recursive function divides data assigned to that task as specified by the recursive function. In some situations, the recursive function is transformed to a non-recursive format or a non-recursive function is transformed to a recursive format.

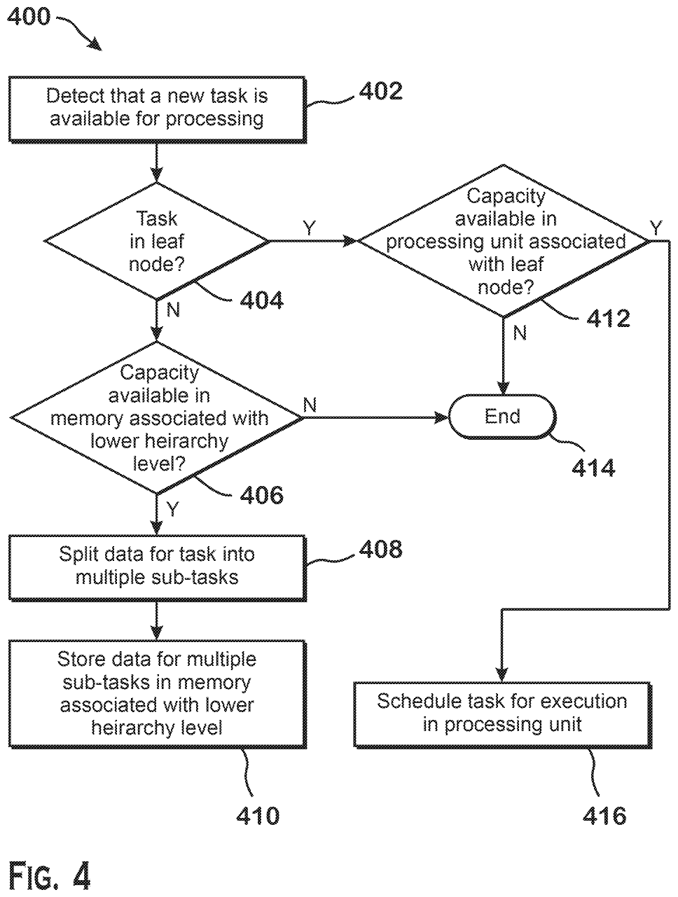

FIG. 4 is a flow diagram of a method 400 for processing data according to a memory organization hierarchy, according to an example. Although described with respect to the system shown and described with respect to FIGS. 1-3, it should be understood that any system configured to perform the method, in any technically feasible order, falls within the scope of the present disclosure.

The method 400 represents activity performed by the hierarchy controller 130 on one task. In general, the method 400 represents processing performed to split up data for one task for tasks in non-leaf nodes or represents processing performed to schedule and perform payload processing for tasks in leaf nodes. It should be understood that the hierarchy controller 130 performs the method 400 many times for different tasks in order to process an entire set of working data through a hierarchy.

The method 400 begins at step 402, where the hierarchy controller 130 identifies a new task for processing. For the data access hierarchy 200, a task is available for processing if the queue 208 for the hierarchy node 206 being analyzed includes a ready entry. For the DAC-based hierarchy, a task is available for processing if a task 302 exists and has no child tasks, has not yet been processed, and is not currently being processed (and is thus not being processed in a processing unit 120 or being processed to split up data).

At step 404, the hierarchy controller 130 determines whether the new task is in a leaf node. If the new task is in a leaf node, then the method proceeds to step 412 and if the new task is not in a leaf node, then the method proceeds to step 406. At step 406, the hierarchy controller 130 determines whether there is capacity available in a memory 122 (or storage element) associated with the hierarchy level that is immediately below the hierarchy level of the task being analyzed. If there is no capacity available, then the method 400 proceeds to step 414, where the method 400 ends. As stated above, the hierarchy controller 130 repeatedly executes the method 400 so that, if at any particular instance of execution of the method 400, there is insufficient available space for a task in a lower hierarchy level, at a later execution, there may be sufficient available space so that the task can be divided up and forwarded to the lower hierarchy level.

If, at step 406, the hierarchy controller 130 determines that there is capacity available in a memory 122 (or storage element) associated with the hierarchy level that is immediately below the hierarchy level of the task being analyzed, then the method proceeds to step 408. At step 408, the hierarchy controller 130 splits data for tasks into multiple sub-tasks. This splitting can be done in any technically feasible manner, as specified by the application for which the work is performed or by the hierarchy controller 130. Splitting data for the tasks includes determining what data, of the data associated with the task, belongs to each subtask and is thus transferred to a different memory unit 122 (or storage element) or to different portions thereof associated with the immediately lower hierarchy level. More specifically, as described above, each node in the hierarchy is associated with a particular memory unit 122 (or storage element) or a specific subdivision of a memory unit 122 or storage element specifically assigned to that node. The splitting of data described above divides the data associated with the task into chunks suitable for the memory units 122 or storage element, or subdivision thereof, associated with the lower hierarchy level.

At step 410, the hierarchy controller stores the data for the multiple sub-tasks in one or more memory units 122 and/or storage elements associated with the hierarchy level that is immediately below the hierarchy level of the task for which the data was split. If the hierarchy used is a queue-based hierarchy (as shown and described with respect to FIG. 2), then the hierarchy controller 130 also manipulates queue entries for both the hierarchy level of the task for which data was split and for the hierarchy level of the sub-tasks. More specifically, the hierarchy controller 130 dequeues the “ready” entry associated with the task for which data was split and enqueues, for the node 206 corresponding to that task, a “wait” entry that indicates that the node 206 is waiting for all sub-tasks to complete. In addition, the hierarchy controller 130 enqueues, for each of the nodes 206 to which the sub-tasks are to be assigned, “ready” entries that indicate that the data for the sub-tasks is ready to be split up or to be processed. If the hierarchy is a DAG-based hierarchy 300 (as shown and described with respect to FIG. 3), then the hierarchy controller 130 manipulates the nodes 312 of the DAG-based hierarchy 300. More specifically, the hierarchy controller 130 adds a new task 302, pointed to by the task 302 for which the data was split up, and located in the immediately-lower hierarchy level 301, for each of the newly generated tasks 302.

Returning back to step 412, at this step, the node has been determined to be a leaf node (at step 404). At step 412, the hierarchy controller 130 determines whether there is capacity available in a processing unit associated with the leaf node. If there is no processing capacity, then the method 400 ends. Again, as described above, the method 400 again executes at a later time, at which time there may be available processing capacity. At step 412, if there is available processing capacity, then the hierarchy controller 130 schedules a task for execution in an available processing unit 120.

When a task in a non-leaf node has finished being split up, that task is considered complete. When a task in a leaf node has finished respective payload processing, that task is considered complete. When all sub-tasks for a task are complete, that particular task is considered complete. This way of detecting completeness is true at each level of the hierarchy, so that when all processing tasks at the bottom of a hierarchy are complete for a particular task at the next highest level, that task is considered complete. When all tasks at that next highest level that are sub-tasks of another task at one level higher in the hierarchy, are complete, that task at one level higher in the hierarchy is considered complete, and so on. In the queue-based hierarchy, when a particular task is considered complete, the corresponding “wait” entry is removed from the queue. In the DAG-based hierarchy, a task is freed when complete. When a non-leaf task that has already been processed has no children (all children are freed), that task is considered complete (and is thus freed).

At any point during or between different executions of the method 400, the hierarchy controller 130 may perform one or more optimizations, such as load balancing or profiling to identify an appropriate processing unit 120 for a task in a leaf node as described above.

Although shown in a particular manner, it should be understood that the various steps of method 400 may vary in different ways, such as order or execution, whether particular steps are executed in parallel versus in sequence, or in other ways.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for processing data, the method comprising:
initiating, at non-leaf nodes of a data access hierarchy, tasks for division of data and transmitting tasks to nodes at lower levels of the data access hierarchy; and
initiating, at leaf nodes of the data access hierarchy, tasks for payload processing,
wherein each task for payload processing performed at the leaf nodes is performed on a data chunk having a size specified by an application, wherein tasks at the leaf nodes do not divide data chunks for transmission to any other nodes for processing.

2. The method of claim 1, wherein the tasks at the leaf nodes comprise tasks specified by the application.

3. The method of claim 2, wherein the tasks at the leaf nodes comprise tasks for processing chunks having a smallest-size of all chunks of data processed through the data access hierarchy.

4. The method of claim 1, wherein tasks at the non-leaf nodes comprise tasks, specified by the application, for dividing data for transmission to a lower level of the data access hierarchy.

5. The method of claim 1, wherein the tasks at the leaf nodes comprise payload processing tasks specified by the application.

6. The method of claim 1, wherein:
each non-leaf node of the data access hierarchy is specified with a chunk size, wherein the chunk size comprises the size of data upon which tasks of the non-leaf nodes are performed.

7. The method of claim 6, wherein:
the data access hierarchy includes a first hierarchy level and a second hierarchy level below the first hierarchy level, wherein the first hierarchy level is associated with the same type of memory unit or storage unit as the second hierarchy level.

8. The method of claim 7, wherein a chunk size for tasks at the first hierarchy level is larger than a chunk size for tasks at the second hierarchy level.

9. The method of claim 6, wherein the data access hierarchy includes a first hierarchy level and a second hierarchy level below the first hierarchy level, wherein the first hierarchy level is associated with a different type of memory unit or storage unit as the second hierarchy level.

10. A system for processing data, the system comprising:
a memory system; and
one or more processors configured to:
initiate, at non-leaf nodes of a data access hierarchy, tasks for division of data and transmitting tasks to nodes at lower levels of the data access hierarchy; and
initiate, at leaf nodes of the data access hierarchy, tasks for payload processing,
wherein each task for payload processing performed at the leaf nodes is performed on a data chunk having a size specified by an application, wherein tasks at the leaf nodes do not divide data chunks for transmission to any other nodes for processing.

11. The system of claim 10, wherein the tasks at the leaf nodes comprise tasks specified by the application.

12. The system of claim 11, wherein the tasks at the leaf nodes comprise tasks for processing chunks having a smallest-size of all chunks of data processed through the data access hierarchy.

13. The system of claim 10, wherein tasks at the non-leaf nodes comprise tasks, specified by the application, for dividing data for transmission to a lower level of the data access hierarchy.

14. The system of claim 10, wherein the tasks at the leaf nodes comprise payload processing tasks specified by the application.

15. The system of claim 10, wherein:
each non-leaf node of the data access hierarchy is specified with a chunk size, wherein the chunk size comprises the size of data upon which tasks of the non-leaf nodes are performed.

16. The system of claim 15, wherein:
the data access hierarchy includes a first hierarchy level and a second hierarchy level below the first hierarchy level, wherein the first hierarchy level is associated with the same type of memory unit or storage unit as the second hierarchy level.

17. The system of claim 16, wherein a chunk size for tasks at the first hierarchy level is larger than a chunk size for tasks at the second hierarchy level.

18. The system of claim 15, wherein the data access hierarchy includes a first hierarchy level and a second hierarchy level below the first hierarchy level, wherein the first hierarchy level is associated with a different type of memory unit or storage unit as the second hierarchy level.

19. A non-transitory computer-readable medium storing instructions that, when executed by one or more processors, cause the one or more processors to:
initiate, at non-leaf nodes of a data access hierarchy, tasks for division of data and transmitting tasks to nodes at lower levels of the data access hierarchy; and
initiate, at leaf nodes of the data access hierarchy, tasks for payload processing,
wherein each task for payload processing performed at the leaf nodes is performed on a data chunk having a size specified by an application, wherein tasks at the leaf nodes do not divide data chunks for transmission to any other nodes for processing.

20. The non-transitory computer-readable medium of claim 19, wherein the tasks at the leaf nodes comprise tasks specified by the application.
